(19) United States
(12) Patent Application Publication
(10) Pub. No.: US 2024/0037180 A1
(43) Pub. Date: Feb. 1, 2024

(54) TRANSIENT CURRENT MANAGEMENT

(71) Applicant: TEXAS INSTRUMENTS INCORPORATED, Dallas, TX (US)

(72) Inventors: Donald E. STEISS, Richardson, TX (US); Timothy ANDERSON, University Park, TX (US); Francisco A. CANO, Sugar Land, TX (US); Anthony Martin HILL, Dallas, TX (US); Kevin P. LAVERY, Sugar Land, TX (US); Arthur REDFERN, Dallas, TX (US)

(21) Appl. No.: 18/071,302

(22) Filed: Nov. 29, 2022

Related U.S. Application Data
(60) Provisional application No. 63/392,528, filed on Jul. 27, 2022.

(51) Int. Cl. G06F 17/16; G06F 7/523

(52) U.S. Cl. CPC G06F 17/16; G06F 7/523

(57) ABSTRACT

In examples, a device comprises control logic configured to detect an idle cycle, an operand generator configured to provide a synthetic operand responsive to the detection of the idle cycle, and a computational circuit. The computational circuit is configured to, during the idle cycle, perform a first computation on the synthetic operand. The computational circuit is configured to, during an active cycle, perform a second computation on an architectural operand.

### CROSS-REFERENCE TO RELATED APPLICATIONS

The present application claims priority to U.S. Provisional Patent Application No. 63/392,528, which was filed Jul. 27, 2022, is titled “IDLE-TIME TRANSIENT CURRENT MANAGEMENT,” and is hereby incorporated herein by reference in its entirety.

### BACKGROUND

Hardware accelerators may be implemented to perform certain operations more efficiently than such operations would be performed on a general-purpose processor such as a central processing unit (CPU). For example, a matrix multiplication accelerator (MMA) may be implemented to perform matrix mathematical operations more efficiently than these operations would be performed on a general-purpose processor. Machine learning algorithms can be expressed as matrix operations that tend to be performance-dominated by matrix multiplication. Accordingly, machine learning is an example of an application area in which an MMA may be implemented to perform matrix mathematical operations such as matrix multiplication.

In hardware implementations of matrix multiplication such as by an MMA, calculations may be performed in a parallel, pipelined computation that may involve nearly-simultaneous evaluations of multiplications, dot product summations, and accumulations. Such computations generally involve a substantial amount of hardware components that operate at relatively high signal transition frequencies. For example, some computing systems that include MMAs may execute about 4096 to about 8192 matrix multiplications per clock cycle at gigahertz rates. The amount of hardware components and/or signal transition frequencies involved in hardware implemented matrix multiplication may contribute to relatively high current demand while computations involving an MMA are active (e.g., during an active cycle).

During some phase of program execution (e.g., during an idle cycle), a computing system including an MMA may not need to perform matrix mathematical operations such that computations involving the MMA are inactive. For example, the computing system may not need to perform matrix mathematical operations due to program structure or transient resource dependencies (e.g., cache misses). While computations involving the MMA are inactive (e.g., during an idle cycle) current demand may be low (e.g., about leakage level current in the MMA) relative to current demand while computations involving an MMA are active (e.g., during an active cycle).

Accordingly, a relatively high transient current (di/dt) can occur when computations involving an MMA start (e.g., when the MMA transitions from an idle cycle to an active cycle) and stop (e.g., when the MMA transitions from an active cycle to an idle cycle).

### SUMMARY

In examples, a device comprises control logic configured to detect an idle cycle, an operand generator configured to provide a synthetic operand responsive to the detection of the idle cycle, and a computational circuit. The computational circuit is configured to, during the idle cycle, perform a first computation on the synthetic operand. The computational circuit is configured to, during an active cycle, perform a second computation on an architectural operand.

### BRIEF DESCRIPTION OF THE DRAWINGS

FIG. 1 is a block diagram of an example device for processing data.

FIG. 2 is a block diagram of an example implementation of the device for processing data with a tightly coupled matrix multiplication accelerator (MMA).

FIG. 3 is a block diagram of an example implementation of the device for processing data with a loosely coupled MMA.

FIG. 4 is a diagram illustrating an example implementation of a matrix multiplication operation in the device for processing data.

FIG. 5 is a diagram illustrating an example implementation of activity leveling during a matrix multiplication operation in the device for processing data.

FIG. 6 is a block diagram of an example implementation of an operand generator.

FIG. 7 is a block diagram of an example implementation of an operand generator.

FIG. 8 is a block diagram of an example implementation of a pseudo-random number generator.

FIG. 9 is a diagram of example waveforms versus time in the device for processing data.

FIG. 10 is a diagram of example waveforms versus time in the device for processing data.

FIG. 11 is a diagram of example waveforms versus time in the device for processing data.

FIG. 12 is a diagram of example waveforms versus frequency in the device for processing data.

The same reference numbers or other reference designators are used in the drawings to designate the same or similar (functionally and/or structurally) features.

### DETAILED DESCRIPTION

As described above, relatively high transient current (di/dt) can occur when computations involving a computational circuit, such as a matrix multiplication accelerator (MMA), start and the circuit transitions from an idle cycle to an active cycle. Relatively high transient current can also occur when computations involving the computational circuit stop and the circuit transitions from an active cycle to an idle cycle. High transient current that occurs when a computational circuit transitions between active cycles and idle cycles can increase inductance sensitivity of a package (or board) design. For example, a direct relationship may exist between inductances and transient current, such that the impedance of an inductance can increase when a magnitude (|di/dt|) of transient current increases and decrease when the magnitude of the transient current decreases.

Increased transient current drawn by an MMA or other computational circuit when transitioning between active cycles and idle cycles can also increase package design complexity and production costs. For example, flattening a response of a power distribution network supplying current drawn by an MMA to avoid resonances that may be excited by narrow current demand pulse widths associated with such increases in transient current can increase package design complexity. In another example, components of power distribution network components involved in supplying current to an MMA are typically hardened to accommodate such increases in transient current, which can increase production costs.

Aspects of this description relate to transient current management managing transient current in a device during parallel matrix computations using activity leveling. In at least one example, the device includes an operand generator that is configured to provide synthetic operands. Generally, an operand can be the object of a mathematical operation or a computer instruction. Operands can include architectural operands and synthetic operands. Architectural operands can represent operands that are processed, manipulated, transformed, or created during some phase of program execution by a general-purpose processor, such as a central processing unit (CPU) or application control logic (ACL). Synthetic operands can represent operands that are generated or created by an operand generator external to any phase of program execution by a general-purpose processor, in accordance with various examples, and the results may be discarded without being used by any program.

Computations involving a given computational circuit can be performed on synthetic operands provided by the operand generator during otherwise idle cycles to consume power. Power consumed by performing computations on synthetic operands provided by the operand generator during idle cycles can reduce a magnitude of transient current drawn by the circuit (referred to herein as activity leveling) when transitioning between active cycles and idle cycles. Reducing transient current drawn by the circuit when transitioning between active cycles and idle cycles can avoid increases in package design inductance sensitivity, complexity, and production costs associated with increases in such transient current.

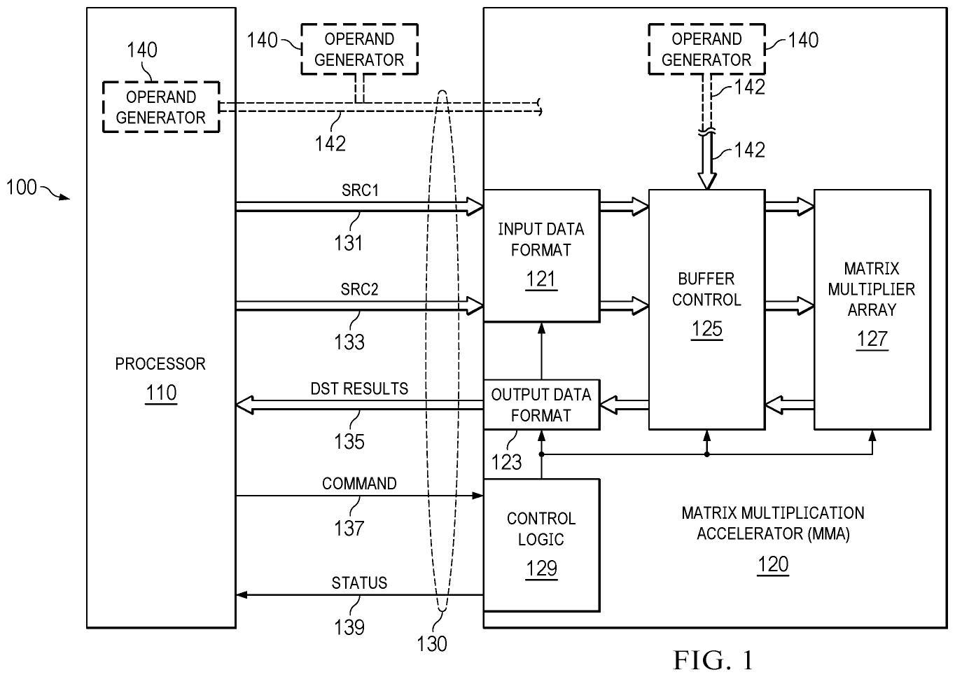

FIG. 1 is a block diagram of an example device 100 for processing data. At least some implementations of the device 100 are representative of an application environment for managing transient current during parallel matrix computations using activity leveling. The device 100 includes a processor 110 that represents a general-purpose processor, such as a CPU or ACL. The device 100 also includes an MMA 120 that represents a hardware accelerator that is coupled to the processor 110 through an interface 130. The MMA 120 is merely one example of a wide array of computational circuits and includes an input data formatter 121, an output data formatter 123, a buffer controller 125, a matrix multiplier array 127, and control logic 129. In examples, the control logic 129 is external to the computational circuit (e.g., the MMA 120) but is still within the device 100. The interface 130 includes a first source data bus (SRC1) 131, a second source data bus (SRC2) 133, a results data bus (DST RESULTS) 135, a command interface (COMMAND) 137, and a status interface (STATUS) 139.

In operation, the processor 110 is configured to provide control signals at the command interface 137, which cause the MMA 120 to control operation of the input data formatter 121, the output data formatter 123, the buffer controller 125, and the matrix multiplier array 127. In some examples, the MMA 120 may store a data structure (not expressly shown) that determines the manner in which the input data formatter 121, the output data formatter 123, the buffer controller 125, and the matrix multiplier array 127 are to operate, and the processor 110 may control the contents of the data structure via the command interface 137. The control signals that the processor 110 provides at the command interface 137 can include opcode instructions, stall signals, formatting instructions, and other signals that modify operation of the MMA 120. The opcode instructions can include an opcode instruction that defines a matrix mathematical operation, such as matrix multiplication operations, direct vector-by-matrix multiplication (which may be useful to perform matrix-by-matrix multiplication), convolution, and other parallel matrix computations. The opcode instructions can also include an opcode instruction that defines a non-matrix mathematical operation, such as a matrix transpose operation, a matrix initialization operation, and other matrix related operations that do not involve a matrix mathematical operation. The formatting instructions can include formatting instructions that define how the MMA 120 is to interpret input data provided at the first source data bus 131 or at the second source data bus 133. The formatting instructions can also include formatting instructions that define how the MMA 120 is to present results to the processor 110 as output data provided at the results data bus 135.

The input data formatter 121 is configured to use formatting instructions provided at the command interface 137 to transform data provided at the first source data bus 131 and data provided at the second source data bus 133 into architectural operands for internal use within the MMA 120. The output data formatter 123 is configured to use formatting instructions provided at the command interface 137 to transform results data generated by computations involving the MMA 120 into output data provided at the results data bus 135. The buffer controller 125 is configured to provide and/or manage memory for storing architectural operands provided by the input data formatter 121 and for storing results data provided by the matrix multiplier array 127. The matrix multiplier array 127 is configured to perform parallel matrix computations using operands provided by the input data formatter 121. The matrix multiplier array 127 is also configured to provide results data generated by parallel matrix computations to the buffer controller 125 for storage. The control logic 129 is configured to modify, responsive to receiving control signals provided by the processor 110 at the command interface 137, operation of the input data formatter 121, the output data formatter 123, the buffer controller 125, and the matrix multiplier array 127. The control logic 129 is also configured to provide signals indicative of a status of the MMA 120 or indicative of a status of an operation performed by the MMA 120 at the status interface 139 for interrogation by the processor 110.

In some examples, the input data formatter 121, the output data formatter 123, the buffer controller 125, and the control logic 129 are implemented using hardware circuit logic. For instance, any suitable hardware circuit logic that is configured to manipulate data bits to facilitate the specific operations attributed herein to the input data formatter 121, the output data formatter 123, the buffer controller 125, and the control logic 129 may be useful. Taking the output data formatter 123 as an example, an example 8-bit by 8-bit vector multiplication yields a 16-bit result. There may be multiple such 16-bit results that are to be summed together, and overflow (e.g., two 16-bit numbers being summed producing a 17-bit result) should be considered. Accordingly, the accumulation may be performed at a 32-bit precision. However, in an example implementation in which the output is to have 8 bits, the output data formatter 123 may be hardware-configured to select which eight bits of the 32-bit sum is to be provided as an output. The output data formatter 123 may also be hardware-configured to perform other operations on data to be output, such as scaling and saturation operations.

The device 100 also includes an operand generator 140 that is configured to provide synthetic operands when activity leveling is enabled. Computations involving the MMA 120 can be performed on synthetic operands provided by the operand generator 140 during otherwise idle cycles to consume power. Power consumed by performing computations on synthetic operands provided by the operand generator 140 during idle cycles can reduce a magnitude of transient current drawn by the MMA 120 when transitioning between active cycles and idle cycles. In at least one example, a magnitude of transient current drawn by the MMA 120 when transitioning between active cycles and idle cycles can be further reduced when the operand generator 140 provides synthetic operands having statistical similarity with architectural operands provided by the processor 110. Computations performed on synthetic operands provided by the operand generator 140 during idle cycles can be architecturally transparent (e.g., without a discernible impact on device architecture, such as memory) by discarding any results data generated by such computations without modifying memory that the buffer controller 125 provides for storing results data. As shown by FIG. 1, the operand generator 140 can be implemented by the device 100 within the MMA 120, within the processor 110, or external to both the processor 110 and the MMA 120. A synthetic data bus 142 (e.g., a bus for providing synthetic data to components) may provide data from the operand generator 140 to other components, such as to the buffer controller 125, as shown.

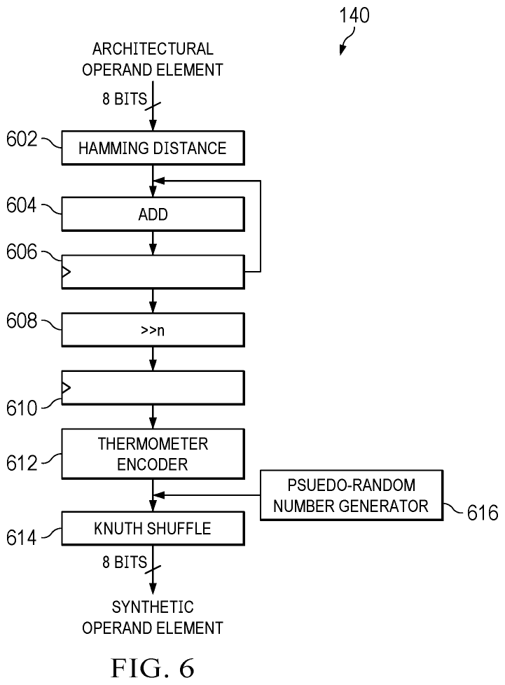

In some examples, the operand generator 140 includes any suitable hardware circuit logic that is configured to perform the actions attributed herein to the operand generator 140. FIG. 6, described in detail below, provides an example hardware configuration for the operand generator 140.

The term “statistical similarity” refers to the similarity between synthetic operands and architectural operands that facilitates a relatively consistent amount of current draw from the MMA 120. More specifically, the current demand of a multiplier may depend on how the inputs to that multiplier are changing. For example, if the same data is provided to the inputs of a multiplier every clock cycle, then that multiplier may consume nearly zero power per clock cycle, because in static complementary metal oxide semiconductor (CMOS) technologies, a circuit consumes significant amounts of power only if the inputs to that circuit change (neglecting leaked power). However, a multiplier that has every input change during each clock cycle will consume a maximum amount of power each clock cycle. It is desirable to maintain a consistent current draw from the MMA 120. However, because the MMA 120's current draw over time is dependent on the sequence of input operands, the sequences of the synthetic and architectural operands should be made to look similar. Thus, for instance, if the architectural operands had, on average, 3 of 8 bits changing each clock cycle, then the synthetic operands should have 3 of 8 bits changing each clock cycle.

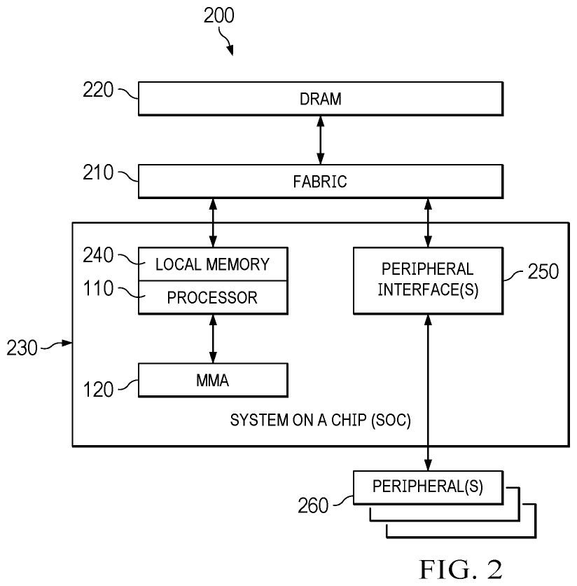

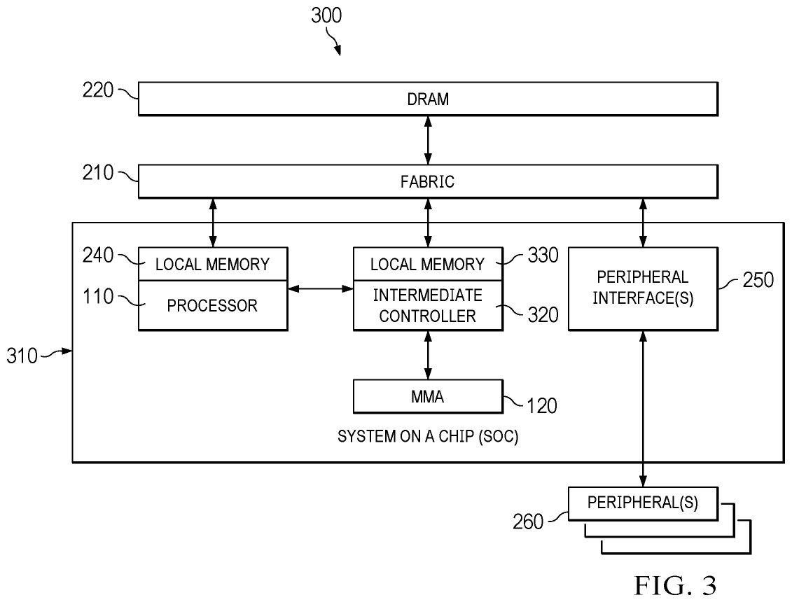

FIGS. 2 and 3 show sample implementations of the examples described herein in broader contexts (e.g., FIGS. 2 and 3 show system-level implementations of the examples described herein). For example, FIG. 2 is a block diagram of a tightly coupled application context 200, in accordance with various examples. In at least one example, tightly coupled generally refers to an application context in which the processor 110 or another general-purpose processor can directly access the MMA 120 without interacting with an intervening controller. The tightly coupled application context 200 is an example implementation of the device 100 in which fabric 210 couples dynamic random-access memory (DRAM) 220 with a system on a chip (SOC) 230. The fabric 210 provides an interconnect architecture for communicating data signals and/or control signals between each component coupled to the fabric 210, such as the DRAM 220, a local memory 240 of the processor 110, and one or more peripheral interfaces 250 of the SOC 230. In the tightly coupled application context 200, the MMA 120 may be tightly coupled to the processor 110 and to the local memory 240 of the processor 110. Accordingly, the MMA 120 can be directly accessed by the processor 110 in the tightly coupled application context 200 to support processing of data from any number of peripherals 260 coupled to the one or more peripheral interfaces 250. The peripherals 260 generally represent hardware devices that provide data, such as image data, audio data, sensor data, radar data, cryptographic data, and other data that can be evaluated using matrix mathematical operations.

FIG. 3 is a block diagram of a loosely coupled application context 300, in accordance with various examples. In at least one example, loosely coupled generally refers to an application context in which the processor 110 or another general-purpose processor interacts with an intervening controller to indirectly access the MMA 120. The loosely coupled application context 300 is an example implementation of the device 100 where fabric 210 couples the DRAM 220 with SOC 310. In the loosely coupled application context 300, the MMA 120 is loosely coupled to the processor 110 through an intermediate controller 320. Accordingly, the processor 110 can indirectly access the MMA 120 through the intermediate controller 320 in the loosely coupled application context 300. Local memory 330 of the intermediate controller 320 can be coupled to the fabric 210 to communicate data signals and/or control signals with other components coupled to the fabric 210, such as the DRAM 220, the local memory 240 of the processor 110, and the one or more peripheral interfaces 250.

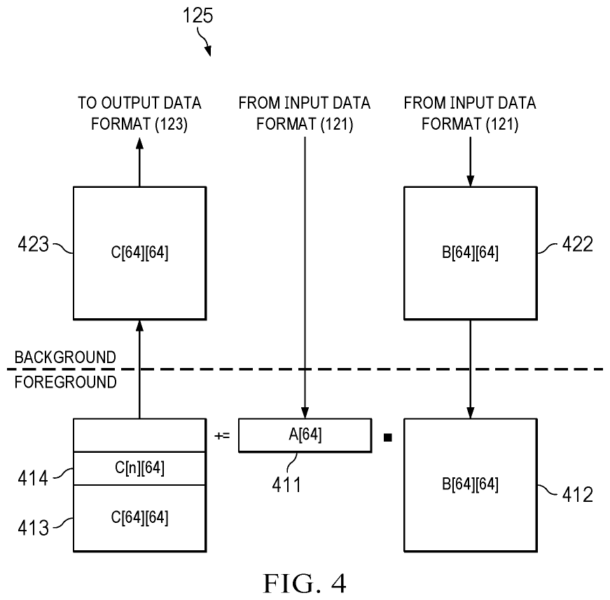

FIG. 4 is a diagram illustrating an example implementation of matrix multiplication in the device 100 for processing data. More particularly, FIG. 4 shows some, but not all, of the contents of the buffer controller 125 (FIG. 1), including buffers useful for storing operands, as described below. FIG. 4 represents various example operands and results of matrix multiplication operations using matrix notation in the form X[n], where each pair of box brackets (e.g., [ ]) represents a dimension of a matrix and n is a number of elements comprising that dimension of the matrix. For example, FIG. 4 uses “A[64]” to represent a row of a matrix multiplier, which in this example, is a single dimension matrix with 64 elements comprising that single dimension. In another example, FIG. 4 uses “B [64][64]” to represent a multiplicand matrix having two dimensions: a first dimension comprising 64 elements; and a second dimension comprising 64 elements.

In this example implementation, and with simultaneous reference to FIGS. 1 and 4, the control logic 129 receives an opcode instruction provided by the processor 110 at the command interface 137 while computations involving the MMA 120 are active. The opcode instruction defines a matrix multiplication operation where computations involving the MMA 120 are active. Accordingly, this example implementation does not involve the MMA 120 transitioning between active cycles and idle cycles.

The buffer controller 125 can be configured to include and/or manage memory having a two-stage pipeline structure including buffers for storing architectural operands provided by the input data formatter 121 and for storing results data provided by the matrix multiplier array 127. The buffer controller 125 may also include additional circuitry, such as circuitry to manage the buffers shown in FIG. 4, although FIG. 4 does not expressly show such circuitry. The two-stage pipeline structure can include a foreground and a background, as shown in FIG. 4. The foreground and background are constructs. As described below, and as shown in FIG. 4, mathematical operations occur in the foreground, and preparations for foreground operations occur in the background. Stated another way, the matrix multiplier array 127 can execute operations on data stored in the foreground of the two-stage pipeline structure. The buffer controller 125 can use the background of the two-stage pipeline structure for data transfer operations.

The MMA 120 loads, responsive to the control logic 129 receiving the opcode instruction, data corresponding to a row of a multiplier matrix from the first source data bus 131. The input data formatter 121 transforms the data that the MMA 120 loads from the first source data bus 131 into an architectural multiplier operand. The input data formatter 121 provides the architectural multiplier operand to the buffer controller 125 to store in a foreground multiplier buffer 411. Multiple dot product computations are computed in parallel within the matrix multiplier array 127 using elements of the architectural multiplier operand stored in the foreground multiplier buffer 411 and columns of a multiplicand operand stored in a foreground multiplicand buffer 412 (the contents of which are provided by a background multiplicand buffer 412, which is populated as described below). The matrix multiplier array 127 provides a result of those multiple dot product computations to the buffer controller 125. During an active cycle, the buffer controller 125 stores the result provided by the matrix multiplier array 127 in a row 414 of a foreground product buffer 413 (e.g., as the result of an addition assignment operation, denoted by the symbol “+=”).

While computations occur within the matrix multiplier array 127, a first background data transfer occurs between the buffer controller 125 and the input data formatter 121 while computations occur within the matrix multiplier array 127 using the foreground multiplier buffer 411 and the foreground multiplicand buffer 412. The first background data transfer involves the input data formatter 121 providing formatted data to the buffer controller 125 to store in a background multiplicand buffer 422 using data that the MMA 120 loads from the second source data bus 133. A second background data transfer also occurs between the buffer controller 125 and the output data formatter 123 while those computations occur within the matrix multiplier array 127. The second background data transfer involves the buffer controller 125 providing the output data formatter 123 with data stored in a background product buffer 423 (which receives its contents from foreground product buffer 413, as FIG. 4 shows) to transform into results data that the MMA 120 provides to the processor 110 via the results data bus 135.

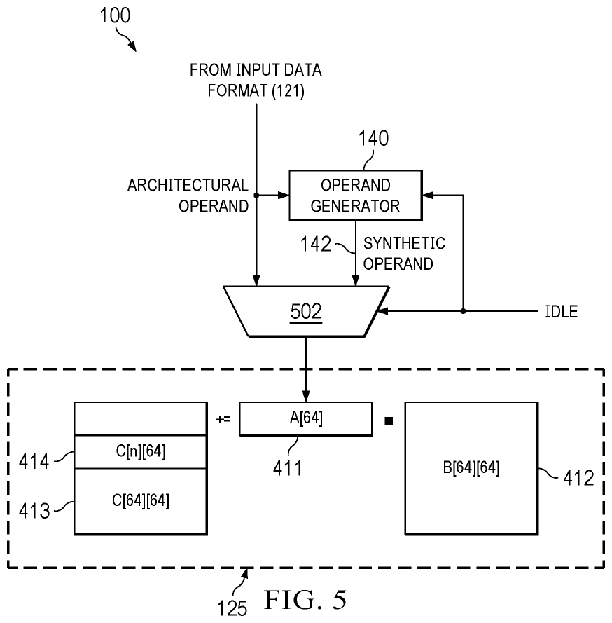

FIG. 5 is a diagram illustrating an example implementation of activity leveling in the device 100 for processing data. FIG. 5 represents various example operands and results of matrix multiplication operations using matrix notation in the form X[n], where each pair of box brackets (e.g., [ ]) represents a dimension of a matrix and n is a number of elements comprising that dimension of the matrix. For example, FIG. 5 uses “A[64]” to represent a row of a matrix multiplier, which in this example, is a single dimension matrix with 64 elements comprising that single dimension. In another example, FIG. 5 uses “B [64]” to represent a multiplicand matrix having two dimensions: a first dimension comprising 64 elements; and a second dimension comprising 64 elements.

Referring to FIGS. 1 and 5, the device 100 includes a multiplexer (MUX) 502 (although FIG. 1 does not expressly show the MUX 502) with a first multiplexer input, a second multiplexer input, a multiplexer output, and a control terminal. The first multiplexer input of the MUX 502 is coupled to the input data formatter 121. The second multiplexer input of the MUX 502 is coupled to the synthetic data bus 142. The multiplexer output of the MUX 502 is coupled to the buffer controller 125. The control logic 129 provides a leveling signal (IDLE) to the control terminal of the MUX 502 and to the operand generator 140. FIG. 1 does not expressly show the control logic 129 coupled to the operand generator 140 to provide IDLE.

In this example implementation, the control logic 129 receives a control signal provided by the processor 110 at the command interface 137 while computations involving the MMA 120 are active. The control signal that the control logic 129 receives cause the computation involving the MMA 120 to stop. Accordingly, FIG. 5 illustrates example operation of the MMA 120 while transitioning from an active cycle to an idle cycle. In at least one example, the control signal is a stall signal that the processor 110 asserts, responsive to encountering a stall condition, prior to the idle cycle. In at least one example, the control signal is an opcode instruction that defines a non-matrix mathematical operation.

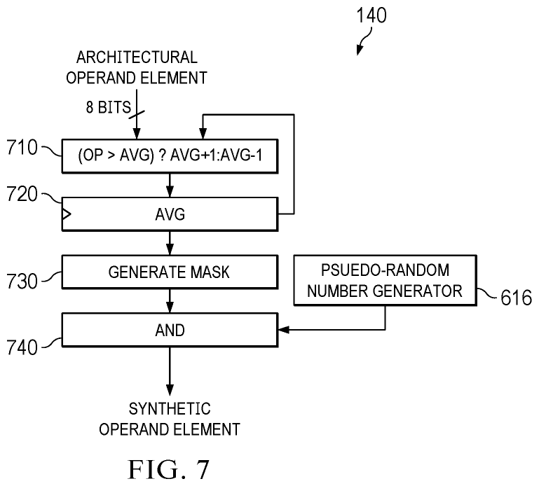

The control logic 129 detects, responsive to receiving the control signal provided by the processor 110 at the command interface 137, an idle cycle. The control logic 129 enables, responsive to detecting the idle cycle, activity leveling in the MMA 120 by asserting the leveling signal IDLE. The operand generator 140 provides, responsive to the control logic 129 enabling activity leveling, a synthetic operand on the synthetic data bus 142 prior to the idle cycle for storage in the foreground multiplier buffer 411. In at least one example, providing the synthetic operand involves the operand generator 140 selecting the synthetic operand from a sample buffer storing a set of sampled architectural operands (e.g., architectural multiplier operands) using a circular index or a pseudo-random index. In at least one example, the operand generator 140 constructs the set of sampled architectural operands by sampling architectural multiplier operands that the input data formatter 121 provides to the buffer controller 125 over a number of active cycles that precede the idle cycle detected by the control logic 129 to determine a pattern or trend in the architectural operands. In at least one example, the synthetic operand provided by the operand generator 140 has a statistical similarity with architectural operands provided by the processor 110, such as a synthetic operand provided by any example implementation of the operand generator 140 described with respect to either FIG. 6 or FIG. 7.

The MUX 502 couples, responsive to the control logic 129 enabling activity leveling signal IDLE, the synthetic data bus 142 and the buffer controller 125. The buffer controller 125 stores, responsive to the MUX 502 coupling the synthetic data bus 142 and the buffer controller 125, the synthetic operand in the foreground multiplier buffer 411. Multiple dot product computations are computed in parallel within the matrix multiplier array 127, during the idle cycle with activity leveling enabled, using elements of the synthetic operand stored in the foreground multiplier buffer 411 and columns of a multiplicand operand stored in the foreground multiplicand buffer 412. The matrix multiplier array 127 provides a result of those multiple dot product computations to the buffer controller 125. During the idle cycle with activity leveling enabled, the buffer controller 125 discards the result provided by the matrix multiplier array 127 without modifying the foreground product buffer 413. As described in greater detail below, performing computations involving the MMA 120 using synthetic operands provided by the operand generator 140 with activity leveling enabled can reduce a magnitude of transient current drawn by the MMA 120 when transitioning between active cycles and idle cycles.

FIG. 6 is a block diagram of an example implementation of the operand generator 140. In FIG. 6, the operand generator 140 provides synthetic operands having statistical similarity with architectural operands provided by the processor 110. As shown by FIG. 6, the operator generator 140 includes a distance circuit 602, a logic gate 604, an accumulation register 606, a shift circuit 608, an averaging register 610, a thermometer encoder 612, a shuffling circuit 614, and a pseudo-random number generator 616. The distance circuit 602 is configured to compute a Hamming distance or population count of a particular element of an architectural operand (“architectural operand element”) provided by the processor 110 for an active cycle. In at least one example, a Hamming distance is a metric for comparing two binary data strings that measures a number of bit positions at which the two binary data strings are different. The logic gate 604 is configured to update a Hamming distance value stored in an accumulation register 606 for an architectural operand element during an active cycle. Updating a Hamming distance value stored in the accumulation register 606 involves the logic gate 604 performing a bitwise AND logic operation on the stored Hamming distance value and on a Hamming distance computed by the distance circuit 602.

The shift circuit 608 is configured to update an average Hamming distance value stored in the averaging register 610 for an architectural operand element once every 2ⁿ active cycles, where n is a natural number. Updating an average Hamming distance value stored in the averaging register 610 for an architectural operand element involves the shift circuit 608 performing a bitwise right shift operation on a Hamming distance value stored in the accumulation register 606 for the architectural operand element. The shift circuit 608 is also configured to reset or clear, responsive to updating the average Hamming distance value stored in the averaging register 610, the Hamming distance value stored in the accumulation register 606. In at least one example, the logic gate 604, the accumulation register 606, the shift circuit 608, and/or the averaging register 610 can be replicated to increase a sampling rate of a Hamming distance or population count of architectural operand elements provided by the processor 110 for an active cycle.

The thermometer encoder 612 is configured to convert an average Hamming distance value stored in the averaging register 610 from binary to an 8-bit thermometer coded value having the average Hamming distance. A pseudo-random number provided by the pseudo-random number generator 616 can control the shuffling circuit 614 to generate a synthetic operand element having statistical similarity with an architectural operand element using thermometer code provided by the thermometer encoder 612. Generating the synthetic operand element can involve the shuffling circuit 614 randomly shuffling the 8-bit thermometer coded value using a shuffling algorithm (e.g., a Fisher-Yates algorithm or a Knuth algorithm) controlled using the pseudo-random number provided by the pseudo-random number generator 616. The operand generator 140 can use the synthetic operand element generated by the shuffling circuit 614 to generate a synthetic operand for the matrix multiplier array 127 to process during an idle cycle.

FIG. 7 is a block diagram of an example implementation of the operand generator 140. In FIG. 7, the operand generator 140 provides synthetic operands having statistical similarity with architectural operands provided by the processor 110. As shown by FIG. 7, the operator generator 140 includes an averaging circuit 710, an averaging register 720, a mask generator 730, a logic gate 740, and the pseudo-random number generator 616. The averaging circuit 710 is configured to update an average value for a particular element of an architectural operand (“architectural operand element”) stored in the averaging register 720 based on a comparison between that stored average value and a current value of an architectural operand element provided by the processor 110 for an active cycle. Updating the average value for the architectural operand element stored in the averaging register 720 involves incrementing the average value by one when a result of that comparison indicates that the average value exceeds the current value of the architectural operand element. Updating the average value for the architectural operand element stored in the averaging register 720 also involves decrementing the average value by one when a result of that comparison indicates that the current value of the architectural operand element exceeds the average value. In at least one example, the averaging circuit 710 generates an average value for an architectural operand element using a least mean squares (“LMS”) algorithm. In at least one example, the LMS algorithm is a fixed step LMS algorithm.

The mask generator 730 is configured to compute a binary mask from the average value for the architectural operand element stored in the averaging register 720. Computing the binary mask involves the mask generator 730 identifying a most significant set bit in the average value stored in the averaging register 720. Computing the binary mask also involves the mask generator 730 setting each bit between the most significant set bit and a least significant bit of the average value stored in the averaging register 720. The logic gate 740 is configured to generate a synthetic operand element having statistical similarity with the architectural operand element. Generating the synthetic operand element involves the logic gate 740 performing a bitwise AND logic operation on a binary mask provided by the mask generator 730 and on a pseudo random number provided by the pseudo-random number generator 616. The operand generator 140 can use the synthetic operand element generated by the logic gate 740 to generate a synthetic operand for the matrix multiplier array 127 to process during an idle cycle.

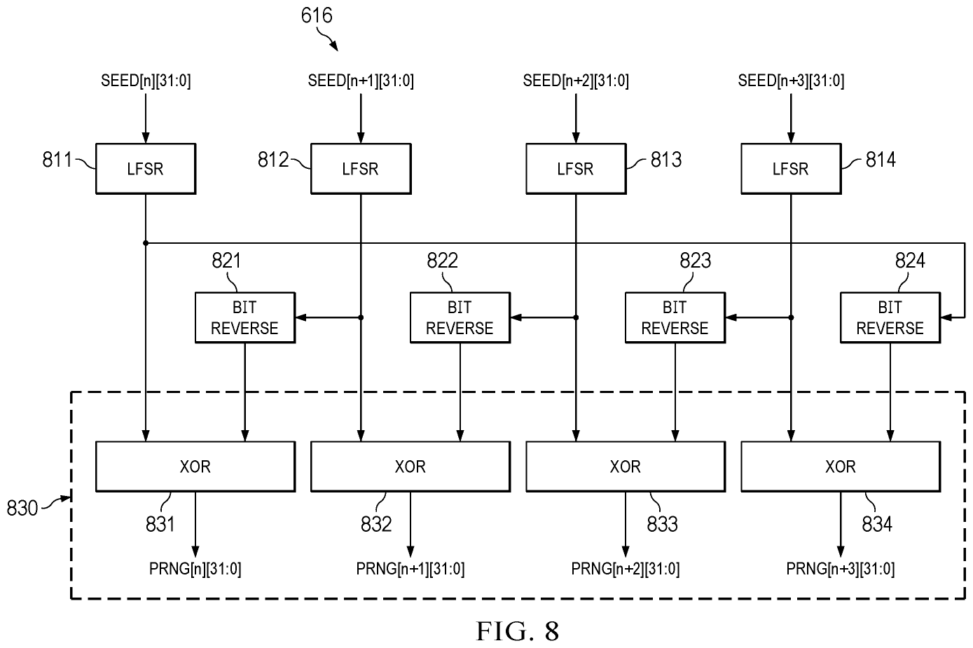

FIG. 8 is a block diagram of an example implementation of the pseudo-random number generator 616. In FIG. 8, the pseudo-random number generator 616 includes a first linear feedback shift register (LFSR) 811, a second LF SR 812, a third LF SR 813, and a fourth LF SR 814. As shown by FIG. 8, each LF SR of the pseudo-random number generator 616 is configured to store a different 32-bit seed provided at an input of that LFSR. For example, the first LFSR 811 is configured to store a first seed (seed[n]), the second LFSR 812 is configured to store a second seed (seed[n+1]), the third LFSR 813 is configured to store a third seed (seed[n+2]), and the fourth LF SR 814 is configured to store a fourth seed (seed[n+3]). An output of each LF SR of the pseudo-random number generator 616 can provide a sequence of pseudo-random values that begin with an initial value set by a seed stored in that LFSR. LFSRs will traverse the possible sequence of numbers that can be represented by N-bits other than zero. The starting seed will reflect where in the sequence each of the 8-bit quantity begins. Any non-zero start value may be useful as a seed.

An output of each LFSR of the pseudo-random number generator 616 is coupled to an input of a different bit reverse register. For example, an output of the first LF SR 811 is coupled to an input of a first bit reverse register 821, an output of the second LF SR 812 is coupled to an input of a second bit reverse register 822, an output of the third LF SR 813 is coupled to an input of a third bit reverse register 823, an output of the fourth LF SR 814 is coupled to an input of a fourth bit reverse register 824. Each bit reverse register of the pseudo-random number generator 616 can perform a bit reversal operation on a pseudo-random value provided at an input of the bit reverse register to provide a pseudo-random value at an output of the bit reverse register.

The pseudo-random number generator 616 also includes a logic circuit 830 with multiple logic gates. In FIG. 8, the multiple logic gates of the logic circuit include a first exclusive OR (XOR) gate 831, a second XOR gate 832, a third XOR gate 833, and a fourth XOR gate 834. An output of each XOR gate is configured to provide a different pseudo-random number to the operand generator 140 for generating synthetic operands. Each XOR gate is configured to provide a pseudo-random number at an output the XOR gate responsive to a bitwise XOR logic operation performed on data provided at an output of one LFSR and on data provided at an output of one bit reverse register that is driven by data provided at an output of another LFSR.

For example, the first XOR gate 831 is configured to provide a first pseudo-random number (prng[n][31:0]) responsive to a bitwise XOR logic operation performed on data provided at an output of the first LFSR 811 and on data provided at an output of the first bit reverse register 821 that is driven by data provided at an output of the second LF SR 812. In another example, the second XOR gate 832 is configured to provide a second pseudo-random number (prng[n+1][31:0]) responsive to a bitwise XOR logic operation performed on data provided at an output of the second LF SR 812 and on data provided at an output of the second bit reverse register 822 that is driven by data provided at an output of the third LF SR 813.

In another example, the third XOR gate 833 is configured to provide a third pseudo-random number (prng[n+2][31:0]) responsive to a bitwise XOR logic operation performed on data provided at an output of the third LFSR 813 and on data provided at an output of the third bit reverse register 823 that is driven by data provided at an output of the fourth LFSR 814. In another example, the fourth XOR gate 834 is configured to provide a fourth pseudo-random number (prng[n+2][31:0]) responsive to a bitwise XOR logic operation performed on data provided at an output of the fourth LFSR 814 and on data provided at an output of the fourth bit reverse register 824 that is driven by data provided at an output of the first LFSR 811.

An LFSR having an output that provides data to a bitwise XOR logic operation of an XOR gate can form a pair of counter-rotating LFSRs with another LF SR that provides data for driving a bit reverse register that provides data to the bitwise XOR logic operation of the XOR gate. For example, the first LFSR 811 and the second LF SR 812 can form a pair of counter-rotating LFSRs with respect to the first XOR gate 831. In another example, the second LFSR 812 and the third LFSR 813 can form a pair of counter-rotating LFSRs with respect to the second XOR gate 832. Another example, the third LFSR 813 and the fourth LFSR 814 can form a pair of counter-rotating LFSRs with respect to the third XOR gate 833. In another example, the fourth LFSR 814 and the first LFSR 811 can form a pair of counter-rotating LFSRs with respect to the fourth XOR gate 834.

In at least one example, using counter-rotating LFSRs to provide pseudo-random numbers to the operand generator 140 for generating synthetic operands can reduce cycle-to-cycle correlation within a sequence of the pseudo-random numbers. Reducing such cycle-to-cycle correlation can mitigate electromagnetic interference (EMI) associated with performing matrix mathematical operations. In at least one example, using counter-rotating LFSRs to provide pseudo-random numbers to the operand generator 140 for generating synthetic operands can reduce die size by reducing a footprint of the pseudo-random number generator 616.

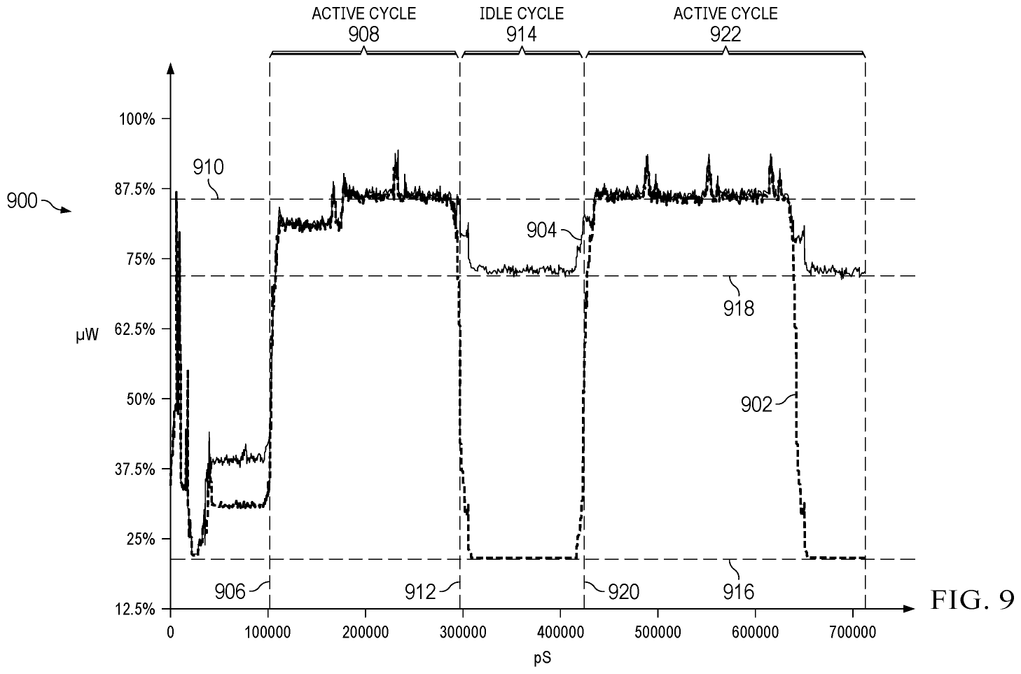

FIG. 9 is a diagram 900 of example waveforms that each show simulated operation of an example implementation of the MMA 120 on the same data set. The diagram 900 includes an x-axis that corresponds to time in units of picoseconds (pS). The diagram 900 also includes a y-axis that corresponds to power in units of microwatts (μW), expressed as percentages of a maximum value (100%) shown on the y-axis. The diagram 900 also includes waveform 902 that represents power consumption as a function of time by the MMA 120 with activity leveling disabled. The diagram 900 also includes waveform 904 that represents power consumption as a function of time by the MMA 120 with activity leveling enabled. At time 906, an active cycle 908 commences as computations (e.g., matrix multiplications) involving the MMA 120 start. For example, the computations involving the MMA 120 may start responsive to the MMA 120 receiving an opcode instruction from the processor 110 that defines a matrix mathematical operation. During the active cycle 908, the waveforms 902 and 904 each approach a first power level 910 that approximates full rate power of the MMA 120. A comparison between the waveforms 902 and 904 shows that, during the active cycle 908, power consumption by the MMA 120 with activity leveling enabled is comparable to power consumption by the MMA 120 with activity leveling disabled.

At time 912, an idle cycle 914 commences as the computations involving the MMA 120 stop. For example, the computations involving the MMA 120 may stop responsive to the MMA 120 receiving an opcode instruction from the processor 110 that defines a non-matrix mathematical operation. Between the active cycle 908 and the idle cycle 914, the waveform 902 decreases from the first power level 910 to a second power level 916. The second power level 916 approximates static leakage power of the MMA 120. Between the active cycle 908 and the idle cycle 914, the waveform 904 decreases from the first power level 910 to a third power level 918. While less than the first power level 910, the third power level 918 is higher than the second power level 916. Accordingly, a variance in power consumption by the MMA 120 with activity leveling enabled when transitioning between the active cycle 908 and the idle cycle 914 is less than a variance in power consumption by the MMA 120 with activity leveling disabled.

At time 920, an active cycle 922 commences as computations (e.g., matrix multiplications) involving the MMA 120 start. For example, the computations involving the MMA 120 may start responsive to the MMA 120 receiving an opcode instruction from the processor 110 that defines a matrix mathematical operation. Between the idle cycle 914 and the active cycle 922, the waveforms 902 and 904 each approach the first power level 910 that approximates full rate power of the MMA 120. Between the idle cycle 914 and the active cycle 922, the waveform 902 increases from the second power level 916 to the first power level 910. Between the idle cycle 914 and the active cycle 922, the waveform 904 increases from the third power level 918 to the first power level 910. The difference between the third power level 918 and the first power level 910 is less than the difference between the second power level 916 and the first power level 910. Accordingly, when transitioning between the idle cycle 914 and the active cycle 922, a variance in power consumption by the MMA 120 with activity leveling enabled is less than a variance in power consumption by the MMA 120 with activity leveling disabled. The diagram 900 shows that variations in power consumption by the MMA 120 when transitioning between active and idle cycles can be reduced by enabling activity leveling.

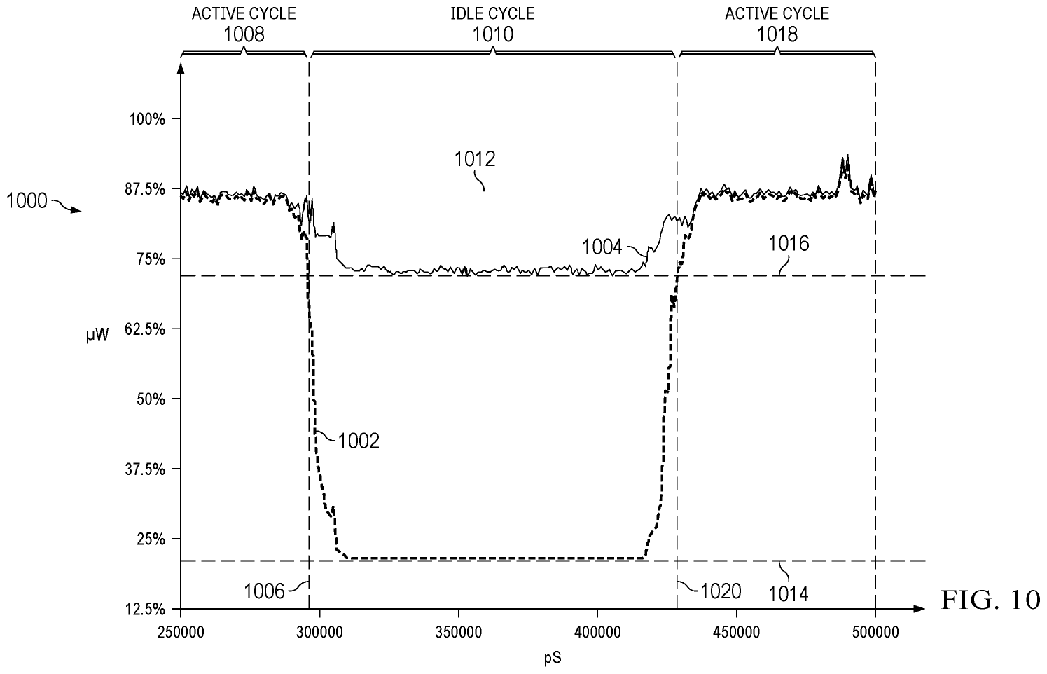

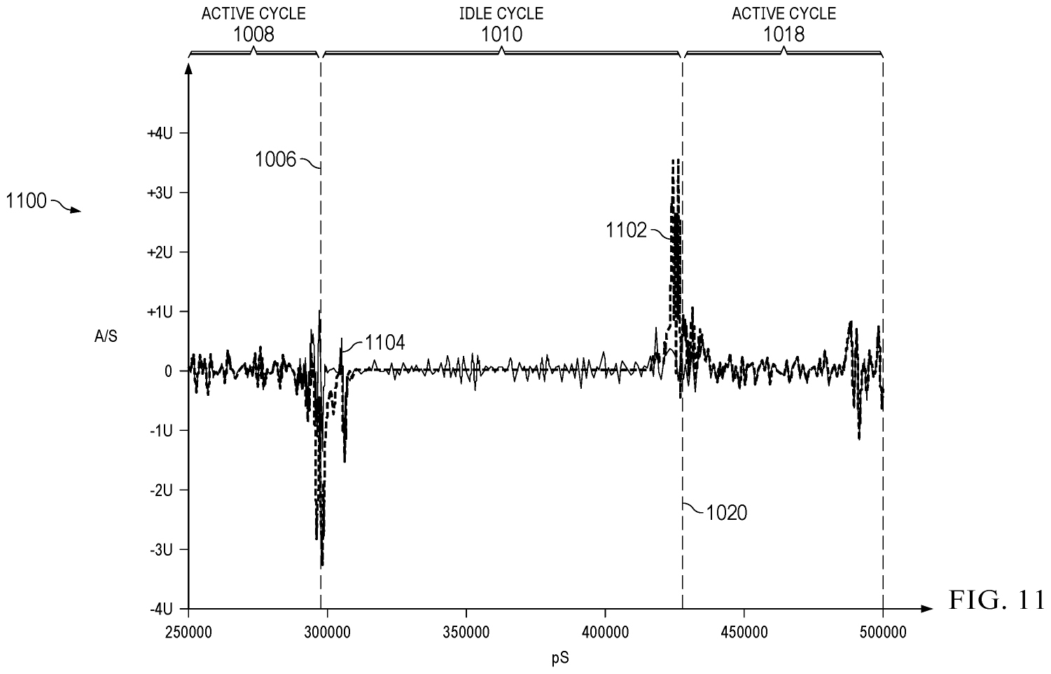

FIG. 10 and FIG. 11 are diagrams of example waveforms that each show simulated operation of an example implementation of the MMA 120 on the same data set. In particular, the diagram 1000 of FIG. 10 and the diagram 1100 of FIG. 11 show power consumption and transient current magnitudes (|di/dt|), respectively, from that simulated operation. The diagram 1000 includes an x-axis that corresponds to time in units of picoseconds (pS). The diagram 1000 also includes a y-axis that corresponds to power in units of microwatts (11W), expressed as percentages of a maximum value (100%) shown on the y-axis. The diagram 1000 also includes waveform 1002 that represents power consumption as a function of time by the MMA 120 with activity leveling disabled. The diagram 1000 also includes waveform 1004 that represents power consumption as a function of time by the MMA 120 with activity leveling enabled. The diagram 1100 includes an x-axis that corresponds to time in units of picoseconds (pS). The diagram 1100 also includes a y-axis that corresponds to transient current magnitude in units of amperes per second (A/S), expressed as positive and negative multiples of a base unit 1U. The diagram 1100 includes waveform 1102 that represents a magnitude of transient current drawn by the MMA 120 with activity leveling disabled as a function of time. The diagram 1100 also includes waveform 1104 that represents a magnitude of transient current drawn by the MMA 120 with activity leveling enabled as a function of time.

At time 1006, each implementation of the MMA 120 transitions from an active cycle 1008 to an idle cycle 1010 when computations (e.g., matrix multiplications) involving the MMA 120 stop. For example, the computations involving the MMA 120 may stop when the processor 110 asserts a stall signal provided to the MMA 120 responsive to the processor 110 encountering a stall condition, such as stall conditions related to program structure or transient resource dependencies (e.g., cache misses). Between the active cycle 1008 and the idle cycle 1010, the waveform 1002 decreases from a first power level 1012 to a second power level 1014. The first power level 1012 approximates full rate power of the MMA 120. The second power level 1014 approximates static leakage power of the MMA 120. Between the active cycle 1008 and the idle cycle 1010, the waveform 1004 decreases from the first power level 1012 to a third power level 1016. The difference between the first power level 1012 and the third power level 1016 is less than the difference between the first power level 1012 and the second power level 1014. Accordingly, when transitioning between the active cycle 1008 and the idle cycle 1010, a variance in power consumption by the MMA 120 with activity leveling enabled is less than a variance in power consumption by the MMA 120 with activity leveling disabled.

With reference to FIG. 11, the waveforms 1102 and 1104 each include spikes proximate to time 1006 that correspond to increases in transient current drawn by each example implementation of the MMA 120 when transitioning between the active cycle 1008 and the idle cycle 1010. A comparison between the waveforms 1102 and 1104 shows that when transitioning between the active cycle 1008 and the idle cycle 1010, a magnitude of transient current drawn by the MMA 120 with activity leveling enabled is less than a magnitude of transient current drawn by the MMA 120 with activity leveling disabled. Accordingly, when transitioning between the active cycle 1008 and the idle cycle 1010, a magnitude of transient current drawn by the MMA 120 with activity leveling enabled is less than a magnitude of transient current drawn by the MMA 120 with activity leveling disabled.

With reference to FIG. 10, an active cycle 1018 commences at time 1020 as computations (e.g., matrix multiplications) involving the MMA 120 start. For example, the computations involving the MMA 120 may start responsive to the MMA 120 receiving an opcode instruction from the processor 110 that defines a matrix mathematical operation. Between the idle cycle 1010 and the active cycle 1018, the waveforms 1002 and 1004 each approach the first power level 1012 that approximates the full rate power of the MMA 120. Between the idle cycle 1010 and the active cycle 1018, the waveform 1002 increases from the second power level 1014 to the first power level 1012. Between the idle cycle 1010 and the active cycle 1018, the waveform 1004 increases from the third power level 1016 to the first power level 1012. The difference between the third power level 1016 and the first power level 1012 is less than the difference between the second power level 1014 and the first power level 1012. Accordingly, a variance in power consumption by the MMA 120 with activity leveling enabled when transitioning between the idle cycle 1010 and the active cycle 1018 is less than a variance in power consumption by the MMA 120 with activity leveling disabled. The diagram 1000 shows that variations in power consumption by the MMA 120 when transitioning between active and idle cycles can be reduced by enabling activity leveling.

With reference to FIG. 11, the waveforms 1102 and 1104 each include spikes proximate to time 1020 that correspond to increases in transient current drawn by each example implementation of the MMA 120 when transitioning between the idle cycle 1010 and the active cycle 1018. A comparison between the waveforms 1102 and 1104 shows that when transitioning between the idle cycle 1010 and the active cycle 1018, a magnitude of transient current drawn by the MMA 120 with activity leveling enabled is less than a magnitude of transient current drawn by the MMA 120 with activity leveling disabled. Accordingly, when transitioning between the idle cycle 1010 and the active cycle 1018, a variance in current demand by the MMA 120 with activity leveling enabled is less than a variance in current demand by the MMA 120 with activity leveling disabled. The diagram 1100 shows that variations in current demand by the MMA 120 when transitioning between active and idle cycles can be reduced by enabling activity leveling.

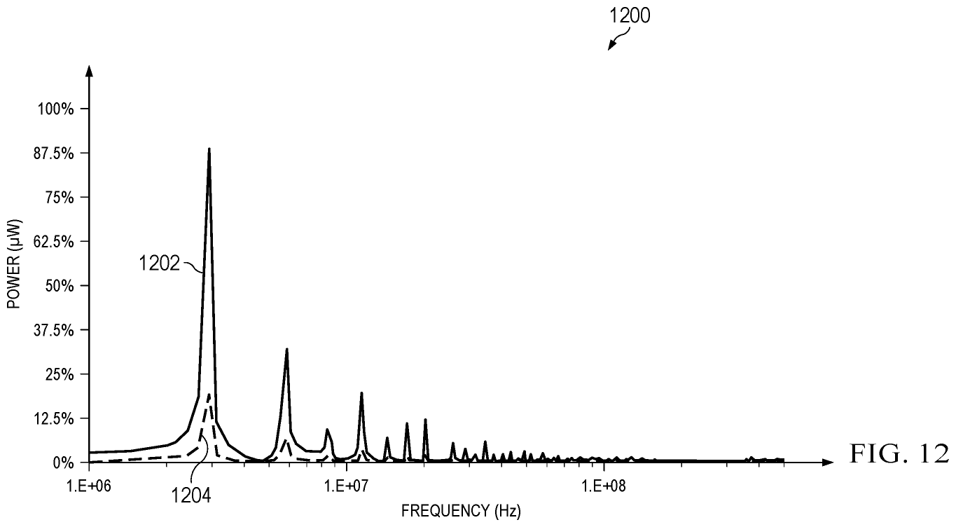

FIG. 12 is a diagram 1200 of example waveforms that each show simulated operation of an example implementation of the MMA 120 on the same data set. The diagram 1200 includes waveform 1202 that represents power consumption as a function of frequency by the MMA 120 with activity leveling disabled. The diagram 1200 also includes waveform 1204 that represents power consumption (expressed in percentages of a maximum value shown on the y-axis (100%)) as a function of frequency by the MMA 120 with activity leveling enabled. A comparison between the waveforms 1202 and 1204 shows a global reduction in power consumption by the MMA 120 with activity leveling enabled relative to power consumption by the MMA 120 with activity leveling disabled.

While examples are provided of an MMA 120 performing operations on synthetic operands, the principle of performing statistical analysis on a set of architectural operands to determine a corresponding set of synthetic operations to use during idle cycles applies equally to any suitable computational circuit, such as a CPU, a graphics processing unit (GPU), fast Fourier transform (FFT) accelerator, a digital signal processor (DSP), or other signal processing circuit.

The term “couple” is used throughout the specification. The term may cover connections, communications, or signal paths that enable a functional relationship consistent with this description. For example, if device A generates a signal to control device B to perform an action, in a first example device A is coupled to device B, or in a second example device A is coupled to device B through intervening component C if intervening component C does not substantially alter the functional relationship between device A and device B such that device B is controlled by device A via the control signal generated by device A.

A device that is “configured to” perform a task or function may be configured (e.g., programmed and/or hardwired) at a time of manufacturing by a manufacturer to perform the function and/or may be configurable (or re-configurable) by a user after manufacturing to perform the function and/or other additional or alternative functions. The configuring may be through firmware and/or software programming of the device, through a construction and/or layout of hardware components and interconnections of the device, or a combination thereof.

Unless otherwise stated, “about,” “approximately,” or “substantially” preceding a value means+/−10 percent of the stated value. Modifications are possible in the described examples, and other examples are possible within the scope of the claims.

What is claimed is:

1. A device, comprising:
an interface adapted to be coupled to a processor; and
a matrix multiplication accelerator (MMA) coupled to the interface, wherein the MMA includes memory with a multiplier buffer, a multiplicand buffer, and a product buffer, and the MMA is configured to:
detect an idle cycle using a control signal provided at the interface by the processor;
load, responsive to detecting the idle cycle, the multiplier buffer with a synthetic operand; and
execute, during the idle cycle, a matrix mathematical operation with the synthetic operand and a multiplicand operand stored in the multiplicand buffer to produce a result to be stored in the product buffer.

2. The device of claim 1, wherein the MMA is configured to discard the result without updating the product buffer.

3. The device of claim 1, wherein the control signal is an opcode instruction, and the MMA is configured to detect the idle cycle when the opcode instruction defines a non-matrix mathematical operation.

4. The device of claim 1, wherein the control signal is a stall signal that is asserted by the processor prior to the idle cycle.

5. The device of claim 1, wherein: the device further includes an operand generator coupled between the MMA and the interface, and the MMA is further configured to receive the synthetic operand from the operand generator.

6. The device of claim 1, wherein the MMA is further configured to receive the synthetic operand from the interface.

7. The device of claim 1, further comprising a multiplexer having a multiplexer output, a first multiplexer input, and a second multiplexer input, wherein the multiplexer output is coupled to the multiplier buffer; the first multiplexer input is coupled to the interface, and the second multiplexer input is coupled to an operand generator of the device.

8. A device, comprising:
an interface adapted to be coupled between a processor and a matrix multiplication accelerator (MMA), wherein the MMA includes a multiplier buffer; and
an operand generator coupled to the interface, wherein the operand generator is configured to:
receive a leveling signal having an asserted value responsive to detection of an idle cycle;
generate, responsive to receiving the leveling signal having the asserted value, a synthetic operand; and
provide, prior to the idle cycle, the synthetic operand at the interface for storage in the multiplier buffer.

9. The device of claim 8, wherein the operand generator is configured to select the synthetic operand from a sample buffer storing sampled architectural operands provided to the multiplier buffer during active cycles that precede the idle cycle.

10. The device of claim 8, wherein the synthetic operand has statistical similarity with an architectural operand provided by the processor during an active cycle that precedes the idle cycle.

11. The device of claim 8, wherein the operand generator includes a pseudo-random number generator, and the operand generator is further configured to:
generate a synthetic operand element for the synthetic operand using a pseudo-random number provided by the pseudo-random number generator, wherein the pseudo-random number generator is configured to provide the pseudo-random number using a pair of counter-rotating linear feedback shift registers with different seeds.

12. The device of claim 8, wherein the operand generator is configured to:
control a Fisher-Yates algorithm or a Knuth algorithm using a pseudo-random number provided by a pseudo-random number generator.

13. The device of claim 8, wherein the operand generator is configured to:
generate a synthetic operand element for the synthetic operand using an average value of an architectural operand element.

14. The device of claim 13, wherein the operand generator is configured to:
generate the average value of the architectural operand element using a least mean squares algorithm.

15. The device of claim 8, wherein the operand generator is configured to:
compute a binary mask using an average value of an architectural operand element; and
generate a synthetic operand element for the synthetic operand using the binary mask and a pseudo-random number provided by a pseudo-random number generator.

16. A device, comprising:
control logic configured to detect an idle cycle;
an operand generator configured to provide a synthetic operand responsive to the detection of the idle cycle; and
a computational circuit configured to:
during the idle cycle, perform a first computation on the synthetic operand; and
during an active cycle, perform a second computation on an architectural operand.

17. The device of claim 16, wherein the computational circuit is configured to discard a result of the first computation.

18. The device of claim 16, wherein the computational circuit is configured to store the synthetic operand in a multiplier buffer prior to the idle cycle.

19. The device of claim 18, wherein the operand generator is configured to select the synthetic operand from a sample buffer storing sampled architectural operands provided to the multiplier buffer during active cycles that precede the idle cycle.

20. The device of claim 16, wherein the synthetic operand has statistical similarity with another architectural operand provided by a processor during an active cycle that precedes the idle cycle.
